(19) United States
(12) Patent Application Publication
(10) Pub. No.: US 2010/0247881 A1
(43) Pub. Date: Sep. 30, 2010

(54) "YO-HEN" like pattern decal and ceramic having "YO-HEN" like pattern

(75) Inventors: Makiko Imai, Nagoya-shi (JP); Toshiyuki Mikata, Nagoya-shi (JP)

Correspondence Address: OLIFF & BERRIDGE, PLC, P.O. BOX 320850, ALEXANDRIA, VA, 22320-4850, US

(73) Assignee: NORITAKE CO., LTD., Nagoya-shi (JP)

(21) Appl. No.: 12/659,930

(22) Filed: Mar. 25, 2010

(30) Foreign Application Priority Data
Mar. 31, 2009 (JP) 2009-087555

(51) Int. Cl. B32B 18/00

(52) U.S. Cl. 428/210

(57) ABSTRACT

A “yo-hen” like pattern decal configured to form a “yo-hen” like pattern on a surface of a ceramic, includes a base material layer containing a first color including a flux, metal oxides Fe₂O₃, Cr₂O₃ and CO₃O₄ and a mat material; and an upper material layer containing a second color that erodes and reacts with the base material layer, and being overlappingly formed abutting with the base material layer in a pattern that is more coarsely scattered than the base material layer.

This application is based on Japanese Patent Application No. 2009-087555 filed on Mar. 31, 2009, the contents of which are incorporated hereinto by reference.

### BACKGROUND OF THE INVENTION

1. Field of the Invention

The present invention relates to a decal for manufacturing a ceramic that has a “yo-hen” like decoration, and a ceramic that has a “yo-hen” like decoration.

2. Description of Related Art

Various decorations are made on the surfaces of the ceramics such as tableware, for instance, by a glaze upon manufacturing. Industrially-mass-produced ceramics are especially required to have stability in quality of even decoration. Accordingly, in general, in manufacturing process of the ceramics, factors of variation in quality are tried to be avoided as possible in order to obtain such as the desired hue. Because, for instance, in the firing process of the ceramics, “yo-hen” in Japanese language (hereinafter and in this specification, referred to as “yo-hen”), that is, the change of a glaze in color development, a tone and a note caused by such as the difference of the firing atmosphere, the temperature and/or the thickness of a glaze, may occur, the factors of variation are controlled to obtain the original hue.

As described above, the “yo-hen” that accidentally occurs should be avoided in view of obtaining the stable quality. On the other hand, since the “yo-hen” pattern provides originality, recently, the originality caused by the “yo-hen” is utilized as one of the technique of decoration of the ceramics. However, since the “yo-hen” is produced by complexity of the various factors in the kiln, it is remarkably difficult to produce a constant “yo-hen” pattern by controlling such as the kind of the glaze, the application or the firing condition, and it is actually impossible to industrially stably manufacture such ceramics having the “yo-hen”.

JP 06-047510 B2, for instance, discloses that the “yo-hen” like pattern is obtained by overlappingly applying such as glazes that are different by 90° C. or over between their softening threshold points, and by 0.2×10⁻⁶ (/° C.) or over between their thermal expansion coefficients, and by firing.

JP 06-047512 B2, for instance, discloses that, on the base glaze applied on the substrate surface of the ceramic, a glaze that has a lower melting point than that of the base glaze is applied, then, a glaze that has higher melting point than that of the base glaze is applied on it, and, after fired, the “yo-hen” like pattern is formed.

JP 06-183866 A, for instance, discloses that, on the tile substrate, one of a first coloring glaze and a second coloring glaze of which the compositions are different each other is applied to provide uneven thickness of the applied layer and the other is applied to provide the flat applied layer, and, then, a third glaze having transparency is applied on them to manufacture the “yo-hen” like pattern tile. Since by this method the proper reactivity between the first coloring glaze and the second coloring glaze can be obtained, the “yo-hen” like pattern can be obtained by the reactivity.

JP 2739695 B2, for instance, discloses that a mat glaze is applied as a ground glaze to provide the even surface of the applied layer on the surface of the substrate of the ceramic, an intermediate glaze that is higher in fire resistance than the ground glaze is insularly applied on it, and, further, an over glaze having transparency is applied on them, and they are fired to obtain a pattern having a note of the material. The pattern obtained in this manner seems similar to the “yo-hen” like pattern. However, since all the manners in JP 06-047510 B2, JP 06-047521 B2, JP 06-183866 A and JP 2739695 B2 utilize the chemical reaction of the glaze and the effect of such as the firing condition cannot be always avoided, it is difficult to constantly obtain even “yo-hen” like patterns.

JP 06-321667 A, for instance, discloses that the “yo-hen” like pattern is printed on the tile to which the glaze is applied, a few kinds of colored glazes are spottedly sprayed and the tile is fired to provide the “yo-hen” like pattern tile. Since, in this manner, the whole design of the “yo-hen” like pattern is formed in printing, and a pattern with the faded profile by spraying is obtained, the “yo-hen” like pattern can be obtained without being affected by such as changeable firing conditions. However, it is yet difficult to mass-produce the production in the constant quality because spraying varies in quality.

It is therefore an object of the present invention to provide a ceramic that has a “yo-hen” like pattern and can be mass-produced in a constant quality, and a decal for preferably manufacturing the ceramic.

### SUMMARY OF THE INVENTION

The object indicated above may be achieved according to a first mode of the invention, which provides a “yo-hen” like pattern decal configured to form a “yo-hen” like pattern on a surface of a ceramic, comprising: (a) a base material layer containing a first color including a flux, metal oxides Fe₂O₃, Cr₂O₃ and CO₃O₄ and a mat material; and (b) an upper material layer containing a second color that erodes and reacts with the base material layer, and being overlappingly formed abutting with the base material layer in a pattern that is more coarsely scattered than the base material layer.

The object indicated above may be achieved according to a second mode of the invention, which provides a ceramic having a “yo-hen” like pattern, comprising: (a) a base layer containing a flux, metal oxides Fe₂O₃, Cr₂O₃ and CO₃O₄ and a mat material; and (b) an upper layer containing a second color that erodes and reacts with the base layer, and being overlappingly formed abutting with the base layer in a pattern that is more coarsely scattered than the base layer.

According to the first mode of the invention, the base material layer contains a first color including a flux, metal oxides Fe₂O₃, Cr₂O₃ and CO₃O₄ and a mat material; and an upper material layer contains a second color that erodes and reacts with the base material layer, and being overlappingly formed abutting with the base material layer in a pattern that is more coarsely scattered than the base material layer. Consequently, in the base material layer, the aforementioned metal compound causes the reaction of the color itself, and in the exposed portion of the generated base layer a mat finishing portion having a rough note by the reaction product and the mat material. In the portion covered with the upper layer, the glossy note is obtained by the reaction to the erosive upper material layer. By this the “yo-hen” like pattern can be easily formed. Since such a “yo-hen” like pattern can be obtained by overlappingly forming the base material layer and the upper material layer on the decal, transferring this onto the surface of the ceramic and being fired, mass-production in the constant quality is possible.

According to the second mode of the invention, a base layer contains a flux, metal oxides Fe₂O₃, Cr₂O₃ and CO₃O₄ and a mat material; and an upper layer contains a second color that erodes and reacts with the base layer, and being overlappingly formed abutting with the base layer in a pattern that is more coarsely scattered than the base layer. Consequently, in the base layer, the aforementioned metal compound causes the reaction of the color itself, and in the exposed portion of the generated base layer a mat finishing portion having a rough note by the reaction product and the mat material. In the portion covered with the upper layer, the glossy note is obtained by the reaction to the erosive upper layer. Accordingly, the ceramic having the “yo-hen” like pattern can be easily obtained. Since such a “yo-hen” like pattern can be obtained by transferring the layers using the decal onto the surface of the ceramic and being fired, mass-production in the constant quality is possible.

Preferably, in the first and second modes of the invention, the first color includes the flux in a range from 35 wt % to 65 wt %, 10 wt % or more each of the metal oxides and the mat material in a range from 5 wt % to 30 wt %. Consequently, since the gloss is restrained especially in the portion where the base layer is exposed, the “yo-hen” like pattern having the further preferable and proper gloss. That is, in order to restrain the gloss, it is preferable to include 10 wt % or more each of the metal oxides, namely, 30 wt % or more in total, and the mat material in a range from 5 wt % to 30 wt %. Accordingly, the flux is to be the balance, preferably, in the range from 35 wt % to 65 wt %.

Preferably, the aforementioned upper material layer and upper layer include at least one of aluminum oxide Al₂O₃, zinc oxide ZnO, cobalt oxide Co₃O₄, nickel oxide NiO, manganese dioxide MnO₂, titanium oxide TiO₂, zirconium silicate ZrSiO₄, copper oxide Cup and metastannic acid H₂SnO₃, as a metal oxide for coloring. In the first and second modes of the invention, these metal oxide for coloring may be added for regulating the color of the upper layer.

Preferably, the aforementioned ceramic is a soft glaze ceramic. The kind of the ceramic for the first mode of the invention in which the decal is used is not limited, however, it is most preferable to use for a soft glaze ceramic. That is, preferably, the aforementioned ceramic of the second mode of the invention is the soft glaze ceramic that is decorated with the “yo-hen” like pattern. The soft glaze is a glaze that melts at a temperature of about 1200° C. or below, contrary to the hard glaze that melts at a high temperature.

Preferably, the aforementioned “yo-hen” like pattern decal includes the intermediate material layer in addition to the aforementioned base material layer and upper material layer. The intermediate material layer is disposed between the base material layer and upper material layer, and has an intermediate density of the pattern between those of the base material layer and upper material layer. The aforementioned ceramic having the “yo-hen” like pattern is provided with the intermediate layer in addition to the aforementioned base layer and upper layer. The intermediate layer has an intermediate density of the pattern between those of the base layer and upper layer. Thus, further variations of the “yo-hen” like pattern can be obtained due to the combination of these patterns. The number of the layers to be laminated is not limited, however, two or three layers are preferable. It is difficult to design it such that the hue and the material note of the base layer appear on the outside through four or more layers.

Preferably, the flux included in the aforementioned base material layer and base layer contains SiO₂—B₂O₃ containing glass including, for instance, Li₂O, Na₂O, K₂O, MgO, CaO, ZnO, B₂O₃, Al₂O₃, SiO₂ and ZrO₂. In the present invention, it is preferable to include 3 mol % or more ZnO to obtain the material note of the mat tone.

Preferably, the flux included in the aforementioned upper material layer and upper layer contains SiO₂—ZnO containing glass including, for instance, Li₂O, Na₂O, K₂O, MgO, CaO, ZnO, B₂O₃, Al₂O₃, SiO₂ and V₂O₅. In the present invention, it is preferable to include V₂O₅ to increase erosional properties of the upper layer and to restrain foaming.

For the mat material, proper ones conventionally used for glazes for ceramics are available, for instance, alumina, zirconium silicate, titanium oxide and zinc oxide. Since the mat material is added to restrain gloss, it is preferable to include it only in the base material layer and the base layer, and not to include it in the upper material layer and the upper layer.

Preferably, the firing step after transferring the “yo-hen” like pattern decal onto the aforementioned ceramic is performed at a temperature of 950 to 1100° C. Although the usual decoration on the soft glaze ceramic is performed in the firing step at a temperature, for instance, of 800 to 850° C., it is preferable to perform at a high temperature of 950° C. or over to have sufficient reaction of the metal oxide added in the base material layer.

### BRIEF DESCRIPTION OF THE DRAWINGS

FIG. 1 illustrates a “yo-hen” like pattern decal of one embodiment according to the present invention, in a sectional diagrammatic view.

FIG. 2 illustrates a pattern of the base material layer provided with the decal in FIG. 1.

FIG. 3 illustrates a pattern of the upper material layer provided with the decal in FIG. 1.

FIG. 4 illustrates steps in the manufacturing process of the decal in FIG. 1 and the decoration process of the ceramic using it.

FIG. 5 illustrates the decal and the ceramic in the transferring step in FIG. 4.

FIG. 6 illustrates an example of the decorated ceramic after the transferring step.

FIG. 7 illustrates the essentials of the ceramic in FIG. 6 in a sectional diagrammatic view.

FIG. 8 illustrates an example of a pattern of the intermediate material layer that is capable of disposing between the base material layer and the upper material layer of the decal in FIG. 1.

FIG. 9 illustrates another example of a pattern of the intermediate material layer that is capable of disposing between the base material layer and the upper material layer of the decal in FIG. 1.

### DETAILED DESCRIPTION OF EXEMPLARY EMBODIMENTS

Hereinafter, there will be described the present invention by reference to the drawings. The figures are appropriately simplified or transformed, and all the proportion of the dimension and the shape of a portion or member may not be reflective of the real one in the following embodiments.

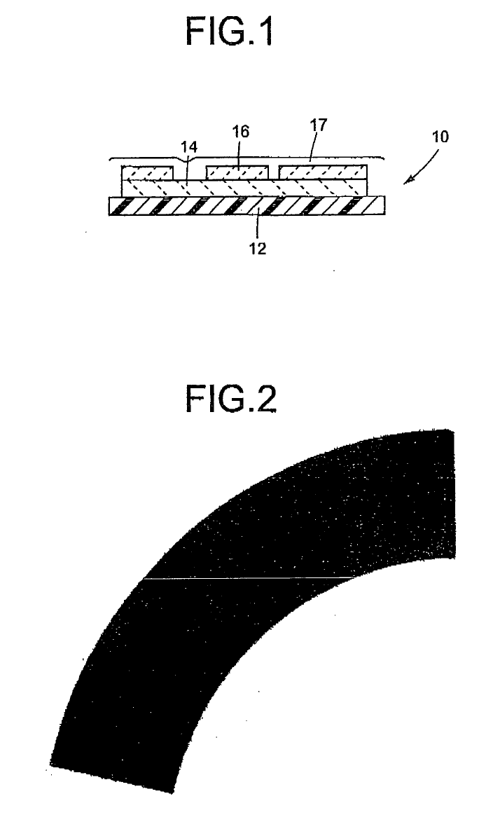

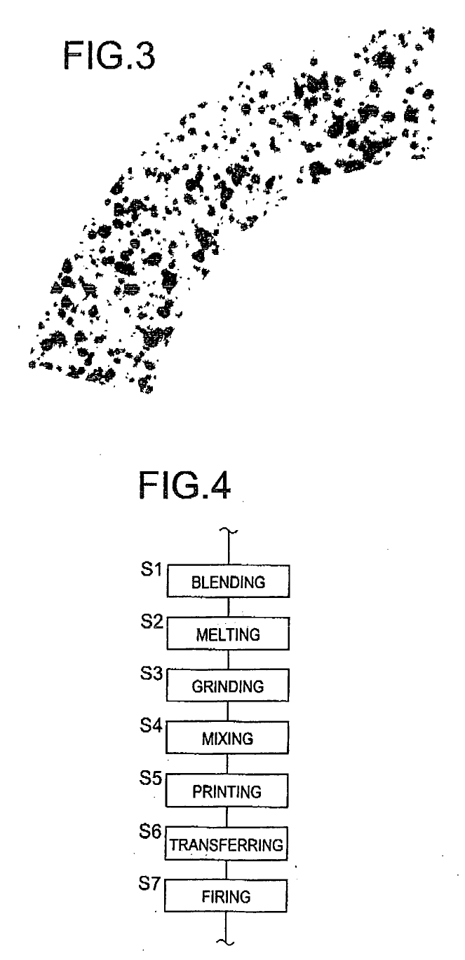

FIG. 1 illustrates a “yo-hen” like pattern decal 10 of one embodiment according to the present invention, in a sectional diagrammatic view. The “yo-hen” like pattern decal 10 (hereinafter, referred to as “decal 10”) includes a base paper 12, and a base material layer 14, an upper material layer 16 and a top coat 17 successively formed on the base paper 12 by printing as well as a conventional one used for transfer decoration of ceramics as shown in FIG. 1, and at least the base material layer 14 and the upper material layer 16 have the annular and planar shape of the doughnut type, for instance. FIG. 2 illustrates an example of a pattern of the base material layer 14 in a part, for instance, about a quarter of the whole circumference, of the decal 10, and a glaze is evenly applied on the whole surface on which there are no designs. FIG. 3 illustrates an example of a pattern of the upper material layer 16 on which a glaze is scatteredly applied. That is, the upper material layer 16 is formed in a coarse pattern comparing with the base material layer 14. FIG. 3 shows about a quarter portion of the decal 10 as well as FIG. 2.

The aforementioned base material layer 14 includes a flux that contains SiO₂—B₂O₃ containing glass including, for instance, Li₂O, Na₂O, K₂O, MgO, CaO, ZnO, B₂O₃, Al₂O₃, SiO₂ and ZrO₂, an oxide such as iron oxide, chromium oxide or cobalt oxide, aluminum oxide and zirconium silicate added as a mat material, an organic combination agent and an organic solvent. The ratio of inorganic components are, for instance, 45 wt % flux, 10 wt % Fe₂O₃, 10 wt % Cr₂O₃, 10 wt % Al₂O₃, 15 wt % ZrSiO₄ and 10 wt % CO₃O₄. The aforementioned flux includes, for instance, in the oxide equivalent, 6.10 mol % Li₂O, 6.60 mol % Na₂O, 1.00 mol % K₂O, 2.59 mol % MgO, 3.10 mol % CaO, 3.10 mol % ZnO, 10.20 mol % B₂O₃, 4.10 mol % Al₂O₃, 60.10 mol % SiO₂ and 3.10 mol % ZrO₂, and its thermal expansion coefficient is about 7.5×10⁻⁶/° C.

The aforementioned upper-material layer 16 includes a flux that contains SiO₂—ZnO containing glass including, for instance, Li₂O, Na₂O, K₂O, MgO, CaO, ZnO, B₂O₃, Al₂O₃, SiO₂ and V₂O₅, a pigment such as copper oxide, an organic combination agent and an organic solvent The ratio of inorganic components are, for instance, 50 wt % flux and 50 wt % CuO. The aforementioned flux includes, for instance, in the oxide equivalent, 2.40 mol % Li₂O, 2.67 mol % Na₂O, 1.60 mol % K₂O, 1.87 mol % MgO, 9.07 mol % CaO, 9.07 mol % ZnO, 2.40 mol % B₂O₃, 5.60 mol % Al₂O₃, 61.91 mol % SiO₂ and 3.39 mol % V₂O₅, and its thermal expansion coefficient is about 7.0×10⁻⁶/° C. That is, the thermal expansion coefficient of it is sufficiently approximate to that of the flux included in the base material layer 14. The composition of the color of the upper material layer 16 is determined so as to have such a thermal expansion coefficient and to obtain high erosional properties and reactivity to the base material layer 14.

FIG. 4 shows the essentials of the manufacturing process of the aforementioned decal 10 and the decoration process of the ceramic using it. The blending step S1 to the printing step S5 is respectively performed for the base material layer 14 and the upper material layer 16. In the blending step S1, glass materials are blended in a predetermined ratio so as to obtain the flux having the aforementioned composition. Next, in the melting step S2, the glass material is molten, for instance, at 1400° C., it is cooled, and is ground in thy grinding by using such as a pot mill in the grinding step S3. The diameter of the ground glass material is, for instance, 10 μM or smaller, so as to easily pass through a screen mesh having about 60 μm of the aperture.

Next, in the mixing step S4, the aforementioned inorganic component and the vehicle is added to the glass powder and mixed in the wet mixing by such as a roll mill. This respectively provides a color for printing to form the aforementioned base material layer 14 and the upper material layer 16. The additional amount of the vehicle may be properly determined so as to obtain viscosity for easy printing. Next, in the printing step S5, the base material layer 14 and the upper material layer 16 are successively overlapped and printed on the base paper 12 in the patterns shown in FIGS. 2 and 3 by using, for instance, the thick-film screen printing, and, further, the top coat 17 is printed. Thus, the decal 10 shown in FIG. 1 can be provided.

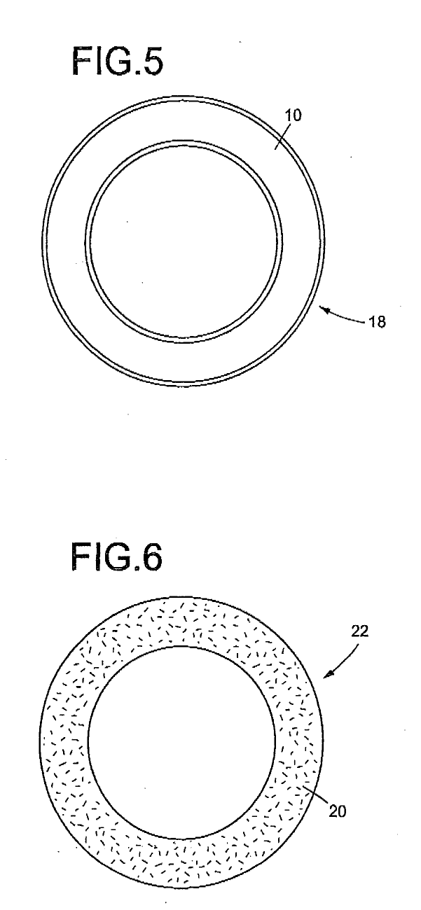

Next, in the transferring step S6, a ceramic to be decorated is prepared, the base material layer 14 and the upper material layer 16 are attached to the top coat 17 removed from the base paper 12 of the decal 10, and they are attached to the predetermined position of the ceramic. FIG. 5 shows this attaching step, and the decal 10 having a doughnut (torus) shape is attached to the inner circumferential portion that is somewhat inner from the outer circumferential edge of the dish substrate 18, concentrically with the dish substrate 18. This dish substrate 18 is made of, for instance, soft glaze ceramic of such as bone china, and the substrate itself is fired and the glaze covering the whole is fired.

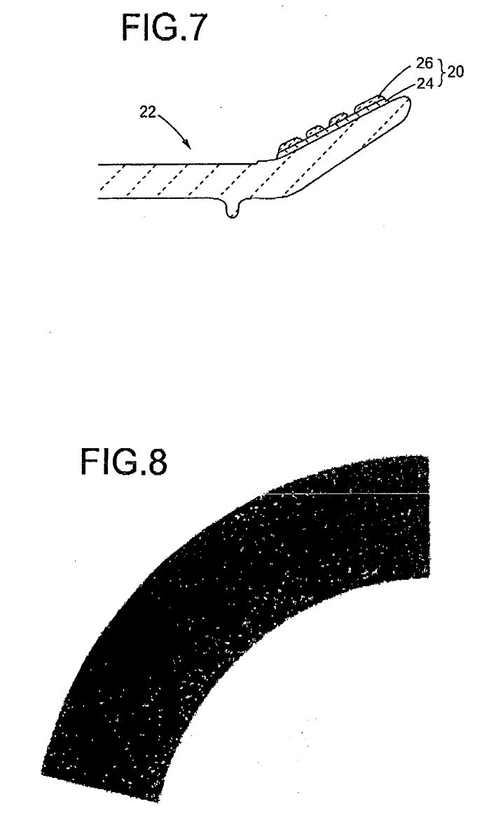

Thus, after the decal 10 is attached, in the firing step S7, the firing process is performed at a proper temperature in the range from 950 to 1100° C. according to the compositions of the base material layer 14 and the upper material layer 16. In this step, organics such as the vehicle and the top coat 17 in the base material layer 14 and the upper material layer 16 are burnt off, and the fluxes included in the base material layer 14 and the upper material layer 16 are molten to form a base layer 24 and an upper layer 26, and, consequently, a dish 22 on which a “yo-hen” like pattern 20 is formed is obtained as shown in FIG. 6. FIG. 7 diagrammatically illustrates a part of the outer circumferential portion of the dish 22 on which the base layer 24 and the upper layer 26 are formed, in a sectional view. Although the real thick dimensions of the base layer 24 and the upper layer 26 are negligibly thin comparing to the thickness of the dish, in FIG. 7, the thicknesses of the base layer 24 and the upper layer 26 are exaggeratedly illustrated comparing to the thickness of the dish 22.

In this embodiment, since the respective fluxes included in the base material layer 14 and the upper material layer 16 have the aforementioned respective compositions, the upper material layer 16 has the physical properties to erode and react to the base material layer 14 and the base material layer 14 includes metal oxides Fe₂O₃, Cr₂O₃, CO₃O₄ and the mat material. Accordingly, in the aforementioned firing step, the aforementioned metal oxides are reacted and the base layer 24 that provides a rough note is generated on the basis of the base material layer 14 including the mat material and the upper layer 26 that provides a glossy note is generated in a portion where the base material layer 14 is covered with the upper material layer 16 that has erosional properties. Furthermore, since the upper material layer 16 is formed in a coarse pattern as shown in FIG. 3, the “yo-hen” like pattern 20 in which the mat-like base layer 24 partly exposes from the glossy upper layer 26 is obtained.

Hereinafter, shown are results of experiments of decoration with regard to various flux compositions and color compositions, with preparing the decal as well as in the aforementioned embodiment. The below Table 1 shows the flux compositions evaluated as the structure material of the (first) color to form the aforementioned base material layer 14. Fb1 in Table 1 is the flux used in the aforementioned embodiment, and fb2 to fb7 are given for comparison. The thermal expansion coefficient was independently measured for the flux, the metal note was evaluated after the color was prepared and applied to the ceramic and fired. The composition of the color used for this evaluation is 45 wt % flux, 10 wt % Fe₂O₃, 10 wt % Cr₂O₃, 10 wt % Al₂O₃, 15 wt % ZrSiO₄ and 10 wt % CO₃O₄.

TABLE 1
Flux Composition (mol %) for Base Layer

| | fb1 | fb2 | fb3 | fb4 | fb5 | fb6 | fb7 |
|---|---|---|---|---|---|---|---|
| Li₂O | 6.10 | 6.60 | 4.21 | 9.96 | 9.92 | 7.51 | 4.00 |
| Na₂O | 6.60 | 4.10 | 8.13 | 1.94 | 1.93 | 7.50 | 4.50 |
| K₂O | 1.00 | 0.30 | 1.68 | 1.03 | 1.03 | — | 3.00 |
| MgO | 2.59 | 2.91 | 1.23 | — | — | — | 1.51 |
| CaO | 3.10 | 3.00 | 1.12 | — | — | — | 1.50 |
| ZnO | 3.10 | 4.60 | — | — | — | — | 1.50 |
| B₂O₃ | 10.20 | 7.60 | 16.95 | 21.99 | 21.90 | 37.50 | 13.50 |
| Al₂O₃ | 4.10 | 5.30 | 4.31 | 5.05 | 5.03 | 15.00 | 6.50 |
| SiO₂ | 60.10 | 63.79 | 61.24 | 57.83 | 57.71 | 32.49 | 63.00 |
| ZrO₂ | 3.10 | 1.80 | 1.43 | 3.00 | 2.49 | — | 1.00 |
| Thermal | 7.5 | 5.4 | 7.6 | 6.1 | 6.0 | 7.2 | 6.7 |
| Expansion | | | | | | | |
| Coefficient | | | | | | | |
| (×10⁻⁶/° C.) | | | | | | | |
| Metal | ◯ | ◯ | X | X | X | X | X |
| Note | | | | | | | |

As shown in Table 1, the thermal expansion coefficient of the flux fb2 is smaller than that of fb1. Consequently, fb2 is difficult to be a replacement of fb1 in view of the difference in the thermal expansion coefficient, however, since a good metal note can be obtained, it is possible to use by properly adjusting the flux compositions of the ceramic and the upper material layer 16 to obtain the proper thermal expansion coefficient.

The thermal expansion coefficients of the fluxes fb3 and fb6 are approximate to that of fb1, the metal note is not obtained. The fluxes fb4, fb5 and fb7 are different in the thermal expansion coefficient and the metal note is not obtained. Consequently, it is deemed that the fluxes fb3 to fb7 are not proper for the structure material of the base material layer 14. It is inferred that it is required to include 3.0 mol % ZnO or more for the flux of the base material layer 14.

The below Table 2 is the flux compositions evaluated for the structure material of the color to form the aforementioned upper material layer 16. Fu1 in Table 2 is the flux used in the aforementioned embodiment, and fu2 to fu5 are given for comparison. Fu4 is the same as fb1 in Table 1 and fu5 is the same as fb2. The composition of the color used for this evaluation is 70 wt % flux, 5 wt % Al₂O₃, 15 wt % ZrSiO₄ and 10 wt % ZnO. The Appearance, etc. was determined by watching such that after the base material layer 14 is formed in the composition of the color used for the evaluation in Table 1 with using the flux fb1 in Table 1, the upper material layer is overlapped on it and fired.

TABLE 2
Flux Composition (mol %) for Upper Layer

| | fu1 | fu2 | fu3 | fu4 | fu5 |
|---|---|---|---|---|---|
| Li₂O | 2.40 | 11.49 | — | 6.10 | 6.60 |
| Na₂O | 2.67 | 5.75 | 1.09 | 6.60 | 4.10 |
| K₂O | 1.60 | 1.37 | 1.63 | 1.00 | 0.30 |
| MgO | 1.87 | 3.01 | 2.99 | 2.59 | 2.91 |
| CaO | 9.07 | 3.01 | 11.15 | 3.10 | 3.00 |
| BaO | — | — | 7.89 | — | — |
| ZnO | 9.07 | 2.74 | 5.44 | 3.10 | 4.60 |
| B₂O₃ | 2.40 | 8.75 | — | 10.20 | 7.60 |
| Al₂O₃ | 5.60 | 3.01 | 5.44 | 4.10 | 5.30 |
| SiO₂ | 61.91 | 57.73 | 57.11 | 60.10 | 63.79 |
| ZrO₂ | — | — | — | 3.10 | 1.80 |
| V₂O₅ | 3.39 | 3.15 | 7.26 | — | — |
| Thermal | 7.0 | — | — | 7.5 | 5.4 |
| Expansion | | | | | |
| Coefficient | | | | | |
| (×10⁻⁶/° C.) | | | | | |
| Appearance, | Glossy | High | Clarity | Foaming | Foaming |
| Etc. | Swell | Fluidity | Lost | | |

As shown in Table 2, with the flux fu1 used in the aforementioned embodiment, the glossy swell was obtained and it is preferable for obtaining the “yo-hen” like pattern. The flux fu2 has too high fluidity, fu3 is lost in clarity, fu4 and fu5 both foamed, and, accordingly, they are difficult to apply to decoration. Since the foamed two fluxes both have no V₂O₅, it is deemed that it is preferable to include it for increasing the erosional properties of the upper material layer 16 and, accordingly, for restraining foaming.

The below Table 3 shows the results of evaluation of the metal note and the color tone after kinds and amounts of such as metal oxides added varied to prepare the underglaze color using the flux fb1 in Table 1, and to apply it to the ceramic and the ceramic was fired. The evaluation of the fluxes fb1 to fb7 in Table 1 was performed using the composition b1 in the below Table 3.

TABLE 3
Composition (wt %) for Base Color

| | b1 | b2 | b3 | b4 | b5 | b6 | b7 | b8 | b9 | b10 |
|---|---|---|---|---|---|---|---|---|---|---|
| Flux fb1 | 45 | 45 | 40 | 45 | 45 | 50 | 45 | 55 | 50 | 45 |
| Fe₂O₃ | 20 | 10 | 30 | 5 | 15 | 5 | — | 10 | 10 | 20 |
| Cr₂O₃ | 10 | 10 | 10 | 10 | — | 5 | 10 | 10 | 10 | 10 |
| Al₂O₃ | 10 | 10 | 10 | 10 | 10 | 10 | 10 | 5 | 10 | 5 |
| ZrSiO₄ | 15 | 15 | — | 15 | 15 | 15 | 15 | 10 | 10 | 10 |
| Co₃O₄ | — | 10 | — | 15 | 15 | 15 | 20 | 10 | 10 | 10 |
| MnO₂ | — | — | 10 | — | — | — | — | — | — | — |
| Metal | High | ◯ | Glossy | Glossy | Glossy | Glossy | Glossy | ◯ | ◯ | ◯ |
| Note | Mat | | | | | | | | | |
| | Tone | | | | | | | | | |
| Color | Dark | Pale & | Dark | Dark | Blue | Dark | Bluish | Pale & | Pale & | Dark |
| Tone | Brown | Dark | Brown | Bluish | | Blue | Green | Dark | Dark | Red |
| | | | | Brown | | | | | | |

In the above Table 3, the composition b1 shows a too high mat tone and it does not seem preferable for the base layer 24 of the “yo-hen” like pattern 20. The compositions b3 to b7 are glossy and they do not seem preferable for the base layer 24 of the “yo-hen” like pattern 20.

On the other hand, the compositions b2 and b8 to b10 show an appropriate mat-tone metal note and it was found that they were preferable for the base layer 24 of the “yo-hen” like pattern 20. Since the compositions that provided preferable results all include Fe₂O₃, Cr₂O₃ and CO₃O₄ of 10 wt % or more in the ratio, it is deemed that it is preferable to include them for obtaining the mat tone.

The below Table 4 shows the results of evaluation of reactivity and the color tone after kinds and amounts of such as pigments added varied to prepare the overglaze color (second color) using the flux fu1 in Table 2, the upper material layer 16 was formed on the base material layer 14 using the color of the composition b1 in Table 3, and the transfer and firing steps were performed. The evaluation of the fluxes fu1 to fu5 for the upper layer was performed by using the composition u1 in the below Table 4.

TABLE 4
Composition (wt %) for Overglaze Color

| | u1 | u2 | u3 | u4 | u5 | u6 |
|---|---|---|---|---|---|---|
| Flux fu1 | 70 | 50 | 60 | 60 | 75 | 80 |
| Al₂O₃ | 5 | — | — | — | — | — |
| ZrSiO₄ | 15 | — | — | — | — | — |
| CuO | — | 50 | — | — | — | — |
| H₂SnO₃ | — | — | — | 40 | — | — |
| TiO₂ | — | — | 40 | — | — | — |
| ZnO | 10 | — | — | — | — | — |
| Fe₂O₃ | — | — | — | — | 15 | 20 |
| Co₃O₄ | — | — | — | — | 5 | — |
| Cr₂O₃ | — | — | — | — | 5 | — |
| Reactivity | ◯ | ◯ | X | ◯ | X | ◯ |
| Color | Transparent | Green | Light | White | Dark | Brown |
| Tone | | | Yellow | | Blue | |

As shown in Table 4, it was found that the compositions u3 and u5 were difficult to use for the purpose in the present embodiment because they were hard to melt and low in erosional properties. It is deemed that the properties of the color was affected by that the added metal oxide (especially, TiO₂, CO₃O₄ and Cr₂O₃) is hard to melt. On the other hand, the compositions u1, u2, u4 and u6 all showed preferable reactivity. The various embodiments of the “yo-hen” like patterns 20 can be obtained by using one of them according to the desired color tone.

Table 5 shows examples of the decals using the underglaze color (first color) and the overglaze color (second color) shown in Tables 3 and 4. In Table 5, Nos. 1 to 6 and 8 are preferable embodiments and No. 7 is given for comparison. The compositions for the color that were determined to be preferable may be used in various combinations and such examples are Nos. 1 to 6 and 8 in Table 5.

TABLE 5
Structure of Decal

| Printing Plate | No. 1 | No. 2 | No. 3 | No. 4 | No. 5 | No. 6 | No. 7 | No. 8 |
|---|---|---|---|---|---|---|---|---|
| A | b6 | b2 | b2 | b8 | b8 | b9 | b1 | b2 |
| C | b4 | — | b4 | — | — | — | — | — |
| D | u2 | u2 | u2 | u4 | u6 | u2 | u1 | u1 |

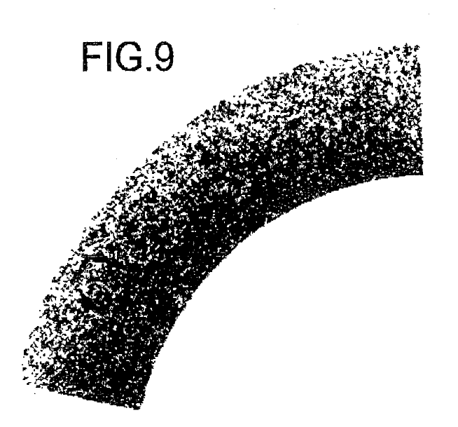

In Table 5, “Printing Plate” indicates the pattern of the plate for the screen printing used upon manufacturing the aforementioned decal 10 in the screen printing method. The printing plate A shows a whole-covered pattern as shown in FIG. 2, and is used for forming the base layer 24. The printing plate D shows a coarsely-scattered pattern as shown in FIG. 3, and is used for forming the upper layer 26. The printing plate C is used for the intermediate layer of the three-layered structure as indicated by the decal No. 1 or 3 in Table 5, as shown in FIG. 8. The printing plate C is a densely-scattered pattern substantially evenly expanding on the whole as well as the printing plate D, and its scattered pattern is more dense than in the printing plate D. It is available to replace the printing plate C by the printing plate B shown in FIG. 9, The printing plate B has the substantially same density as the printing plate C, the inner circumferential portion has more dense pattern than the outer circumferential portion.

The decals Nos. 1 and 3 in Table 5 have the three-layered structure in which the printing plates A, C and D are disposed in series. Although the underglaze colors b6 and b4 used in the printing plates A and C of the decal No. 1 are determined to be improper colors in Table 3, they are included here in the embodiment. They are improper in the aforementioned two-layered structure, they are preferably used to form the “yo-hen” like pattern 20 in the three-layered structure.

Above described in detail is the present invention with reference to the drawings. It is to be understood that the present invention may be embodied with other changes, improvements, and modifications that may occur to a person skilled in the art without departing from the scope and spirit of the invention defined in the appended claims.

What is claimed is:

1. A “yo-hen” like pattern decal configured to form a “yo-hen” like pattern on a surface of a ceramic, comprising:
a base material layer containing a first color including a flux, metal oxides Fe₂O₃, Cr₂O₃ and CO₃O₄ and a mat material; and
an upper material layer containing a second color that erodes and reacts with the base material layer, and being overlappingly formed abutting with the base material layer in a pattern that is more coarsely scattered than the base material layer.

2. The “yo-hen” like pattern decal of claim 1, wherein the first color includes the flux in a range from 35 wt % to 65 wt %, 10 wt % or more each of the metal oxides and the mat material in a range from 5 wt % to 30 wt %.

3. The “yo-hen” like pattern decal of claim 1, wherein the upper material layer includes at least one of Al₂O₃, ZnO, CO₃O₄, NiO, MnO₂, TiO₂, ZrSiO₄, CuO and H₂SnO₃, as a metal oxide for coloring.

4. The “yo-hen” like pattern decal of claim 1, wherein the ceramic is a soft glaze ceramic.

5. A ceramic having a “yo-hen” like pattern, comprising:
a base layer containing a flux, metal oxides Fe₂O₃, Cr₂O₃ and CO₃O₄ and a mat material; and
an upper layer containing a second color that erodes and reacts with the base layer, and being overlappingly formed abutting with the base layer in a pattern that is more coarsely scattered than the base layer.

6. The ceramic of claim 5, wherein the base layer includes the flux in a range from 35 wt % to 65 wt %, 10 wt % or more each of the metal oxides and the mat material in a range from 5 wt % to 30 wt %.

7. The ceramic of claim 5, wherein the upper layer includes at least one of Al₂O₃, ZnO, CO₃O₄, NiO, MnO₂, TiO₂, ZrSiO₄, CuO and H₂SnO₃, as a metal oxide for coloring.

8. The ceramic of claim 5, being a soft glaze ceramic.
